(19) United States
(12) Patent Application Publication
(10) Pub. No.: US 2025/0081049 A1
(43) Pub. Date: Mar. 6, 2025

(54) METHOD AND SYSTEM TO PREVENT OUTGOING HANDOVER REQUESTS FOR SDL CELLS

(71) Applicant: Rakuten Symphony, Inc., Tokyo (JP)

(72) Inventors: Hanumantappa KORACHARA MAREPPA, Bangalore (IN); Sai Naga Venkata Ravi Kiran KOLA, Bangalore (IN)

(73) Assignee: Rakuten Symphony, Inc., Tokyo (JP)

(21) Appl. No.: 18/639,432

(22) Filed: Apr. 18, 2024

(30) Foreign Application Priority Data
Aug. 31, 2023 (IN) 202341058398
Sep. 29, 2023 (IN) 202341058398

(51) Int. Cl. H04W 36/00; H04W 36/08

(52) U.S. Cl. CPC H04W 36/0058; H04W 36/0016; H04W 36/0061; H04W 36/00837; H04W 36/08

(57) ABSTRACT

The present disclosure relates to techniques for preventing outgoing Handover requests for SDL cells from the source BS. In one implementation, a predefined configuration of SDL-frequency for the SDL cell is provided to the source base station. In another implementation, SDL cell information is provided in one or more Information Element(s). In yet another implementation, the source base station may receive update about the SDL cell information from an SMO framework. Post receiving the SDL cell information, the source base station may update its neighbour cell table. In case, the source base station receives the measurement report shared by UE for handover and the measurement report contains request for SDL cell then, based on the updated information in the neighbour cell table, source base station may not trigger the HO request for the SDL cell and HO KPIs degradation may be avoided.

### CROSS REFERENCE TO RELATED APPLICATION(S)

This application claims priority based on India Provisional Patent Application No. 202341058398 filed Aug. 31, 2023, and India Non-Provisional Patent Application No. 202341058398 filed Sep. 29, 2023.

### TECHNICAL FIELD

The present disclosure generally relates to the field of wireless communication. More particularly, the present disclosure relates to techniques for preventing outgoing handover requests for SDL (Supplementary Downlink) Cells and optimizing handover (HO) requests.

### BACKGROUND

The following description includes information that may be useful in understanding the present disclosure. It is not an admission that any of the information provided herein is prior art or relevant to the present disclosure, or that any publication specifically or implicitly referenced is prior art.

Rapid technological advancements and evolution of wireless standards like 5G has led to revolutionary growth in field of wireless communication. However, phenomenon like network congestion, interference, frequency coverage etc., pose a serious challenge in the field of wireless communication. In addition, PIM (Passive Intermodulation) is also a significant issue in the cellular industry and is extremely difficult to troubleshoot. In cell communication systems, PIM may create interference which may impact receiver sensitivity or may even inhibit communication completely. If PIM cancellation feature is not supported by the network i.e., operator has not configured the network to cancel PIM then it may strongly impact the performance of the wireless communication. Specially victim band's Uplink (UL) may have to face serious performance challenges. To mitigate this, the victim band's UL is completely blanked and converted to SDL (Supplementary Downlink) cell with different downlink frequency so that it doesn't interfere with the uplink frequency.

Now, in the existing scenario, when UE shares measurement reports for handover (HO) to the source base station for one of the cell hosted by a target base station, the source base station tries to approach the target base station by sending a request. However, at that instance, the source base station is unaware about the information that the request is intended for an SDL cell hosted by the target base station or not. Since the target base station is aware of request received for the SDL cell, it initiates HO preparation failure, and this leads to degradation of HO KPIs (key performance indicators). In case the SDL carrier is neighbour of multiple eNB's, the HO preparation KPI's may degrade to a larger extent.

Therefore, there exists a need for a technique that can overcome the above-mentioned challenges and optimize handover (HO) requests in such a manner that degradation of HO preparation KPIs may be avoided while maintaining the overall performance efficiency of the network.

### SUMMARY

The present disclosure overcomes one or more shortcomings of the prior art and provides additional advantages. Embodiments and aspects of the disclosure described in detail herein are considered a part of the claimed disclosure.

In one non-limiting embodiment of the present disclosure, a method performed by a source Base station (BS) for optimizing HO requests is disclosed. The method comprises receiving Supplementary Downlink (SDL) cell information for one or more base stations neighbouring the source base station, wherein the one or more base stations neighbouring the source base station host an SDL cell. The method further comprises updating the received SDL cell information for the one or more base stations in a neighbour cell table which is being maintained by the source base station. Further, the method includes receiving a measurement report for a HO from a user equipment (UE) served by the source base station for a target base station among the one or more base stations. The method also comprises in response to receiving the measurement report determining from the neighbour cell table, whether a cell reported for the HO in the measurement report is the SDL cell hosted by the target base station and avoiding triggering of the HO for the SDL cell hosted by the target base station based on the determination.

In another embodiment of the present disclosure, a source Base station for optimizing HO request is disclosed. The Source Base station comprises a memory and at least one processor which is coupled to the memory and is in turn configured to receive Supplementary Downlink (SDL) cell information for one or more base stations neighbouring the source base station, wherein the one or more base stations neighbouring the source base station host an SDL cell. The processor in conjunction with the memory is further configured to update the SDL cell information for the one or more base stations in a neighbour cell table maintained by the source base station. The source Base station is further configured to receive a measurement report for a HO from a user equipment (UE) served by the source base station for a target base station among the one or more base stations. Further, upon receiving the measurement reports, the source Base station is configured to determine from the neighbour cell table, whether a cell reported for the HO in the measurement report is the SDL cell hosted by the target base station and consequently avoid triggering of the HO for the SDL cell hosted by the target base station based on the determination.

In yet another embodiment of the present disclosure, a non-transitory computer readable media for optimizing Handover (HO) requests at a source base station, the non-transitory computer readable media comprising one or more instructions which, when executed by at least one processor cause the at least one processor to receive Supplementary Downlink (SDL) cell information for one or more base stations neighbouring the source base station, wherein the one or more base stations neighbouring the source base station host a SDL cell. The non-transitory computer readable media further comprises one or more instructions to update the SDL cell information for the one or more base stations in a neighbour cell table maintained by the source base station receive a measurement report for a HO from a user equipment (UE) served by the source base station for a target base station among the one or more base stations. Based on the received measurement reports, the non-transitory computer readable media further comprises one or more instructions to determine from the neighbour cell table, whether a cell reported for the HO in the measurement report is the SDL cell hosted by the target base station in response to the received HO measurement report and consequently avoid triggering of the HO for the SDL cell hosted by the target base station based on the determination.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Apparent from the detailed description set forth below when taken in conjunction with the drawings in which like reference characters identify correspondingly throughout. Some embodiments of system and/or methods in accordance with embodiments of the present subject matter are now described, by way of example only, and with reference to the accompanying FIGS., in which:

FIG. 1a depicts an exemplary prior art environment 100a where the source base station transmits the HO request to a target base station without knowing the associated SDL cell information before hand;

FIG. 1b depicts an exemplary environment 100b where the source base station maintains information of SDL cell in its neighbour Cell Table and accordingly decide for transmission of the HO request to a target base station, in accordance with an embodiment of the present disclosure;

FIG. 2 depicts an exemplary block diagram 200 illustrating a system to optimize the process of HO request generation by the source base station, in accordance with another embodiment of the present disclosure;

FIG. 3 depicts an exemplary environment 300 where the source base station and target base station are configured to setup X2 interface between them for communication, in accordance with yet another embodiment of the present disclosure;

FIG. 4 depicts an exemplary block diagram 400 illustrating a system to optimize the HO request generation by the source base station using Information Elements via X2 setup, in accordance with another embodiment of the present disclosure;

FIG. 5 depicts an exemplary architecture 500 illustrating O-RAN configuration, in accordance with an embodiment of the present disclosure;

FIG. 6 depicts an exemplary environment 600 illustrating session establishment procedure between base station(s) and an SMO framework, in accordance with another embodiment of the present disclosure;

FIG. 7 depicts an exemplary block diagram 700 illustrating event subscription and information exchange between base station(s) and SMO framework, in accordance with yet another embodiment of the present disclosure;

FIG. 8 depicts an exemplary environment 800 illustrating session termination procedure between the base station(s) and SMO, in accordance with the still another embodiment of the present disclosure;

FIG. 9 represents a flowchart 900 of an exemplary method performed by the source base station for optimizing HO request, in accordance with another embodiment of the present disclosure;

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in a computer readable medium and executed by a computer or processor, whether or not such computer or processor is explicitly shown.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

In the present disclosure, the term “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, “include”, “including”, or any other variations thereof, are intended to cover a non-exclusive inclusion, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

The terms like “at least one” and “one or more” may be used interchangeably or in combination throughout the description.

The terms like “base station”, “eNB” and “gNB” may be used interchangeably or in combination throughout the description.

The terms like “SMO”, “SMO framework” “Service Management and Orchestration Framework” may be used interchangeably or in combination throughout the description.

The terms like “neighboring BS”, “neighboring base station”, “target base station” and “target BS” may be used interchangeably or in combination throughout the description.

Among other challenges that have emerged with the rapid advancements in 5G technology like network congestion, interference etc., PIM persist to pose a complex problem to troubleshoot even in the current scenario. To overcome this challenge, network operator generally configures the network parameters such that they tend to cancel out the generated PIM, but this technique fails to yield results if the operator fails to configure the said feature due to any specific reason, thus, severely hampering the performance of wireless communication. Specifically, the Uplink (UL) of the affected band, known as the victim band, may encounter considerable performance challenges. To address this issue, the UL of the victim band is effectively silenced and transformed into a Supplementary Downlink (SDL) cell, operating on a distinct downlink frequency, thus preventing interference with the uplink frequency. Now, in the existing scenario, when UE shares the measurement report for handover with the source base station (eNB or gNB) for a particular cell of the target base station, the source base station tries sends a request for HO to the target base station. Since, at that instance, the source base station is unaware about the information that the requested cell is an SDL cell hosted by the target base station or not. Thus, the request for HO is initiated but, since the target base station is aware of request received for the SDL cell, it initiates HO preparation failure. Further, in case, SDL carrier is neighbour of multiple base stations, the HO preparation KPI's will degrade.

To overcome the challenges as described in the foregoing paragraph, the present disclosure aims to provide techniques for preventing outgoing handover requests for SDL (Supplementary Downlink) Cells. In order to achieve this, the present disclosure aims to provide the information relating to configuration of a particular cell as SDL cell well in advance thus preventing the triggering of HO request for that particular cell. Present disclosure provides different embodiments for achieving this objective, one of which relates to receiving a configuration like SDL-frequency for the SDL carrier from a network operator and maintaining the same in neighbor cell table present on the base station. Accordingly, as a part of configuration update, network operator may mark SDL frequency for a particular base station and this information is updated to all the neighboring base stations so that they may avoid triggering of HO request for that reported SDL cell. In yet another embodiment, the present disclosure describes including some IEs (Information Elements) as part of X2 procedure/base station config update procedure which indicate that the cell has been configured as SDL cell. In this embodiment, the source base station may update this information in its neighbor cell table and thus not trigger HO request for that particular cell. In yet another embodiment, the base station updates its neighbour details and SDL information to a SMO (Service Management and Orchestration) Framework via an interface and SMO framework in turn may update SDL information to its neighbouring base stations so that the neighbouring base stations may mark that particular cell as SDL in their corresponding neighbouring cell table and not trigger any HO request for that particular cell. Thus, the different embodiments recited by the present disclosure aim to prevent HO request being triggered for the SDL cell at the source base station only, accordingly HO request for SDL cell is not generated and degradation of HO KPI may be avoided at first instance.

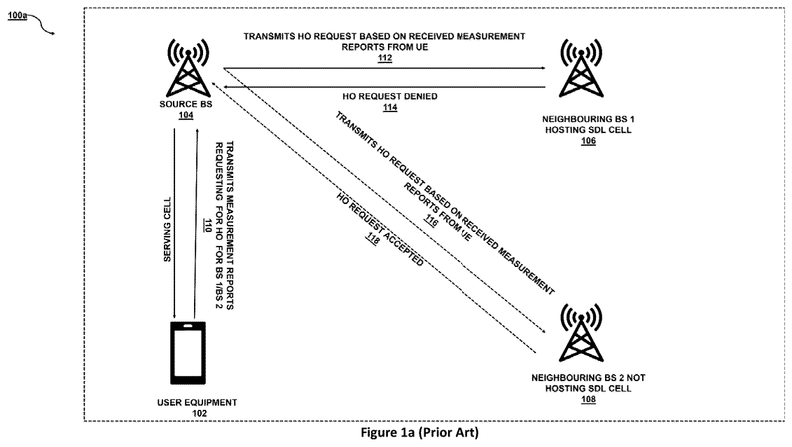

FIG. 1a illustrates an exemplary prior art environment 100a where a UE (user equipment) 102 is being served by a source BS (base station/eNB) 104 at any instant of time. Now due to many factors like encountering interferences in the network cell being served by the source BS 104 or due to degraded signal quality for data reception on the UE 102 or due to change in location of the UE 102, the measurement report shared by UE indicates the need for handover to the source BS 104. The measurement report shared by UE may contain information about the cell of the one of the neighbouring BS on which handover may be performed. In one non-limiting embodiment of the present disclosure, the UE 102 generates A3/A4/A5 measurement reports which contain the HO request for a specified neighbouring BS. These reports constitute part of the Mobility Management (MM) procedures that helps to ensure seamless connectivity and handover of a mobile device as it moves across different cells in a cellular network. To elaborate, A3 report is a measurement report provided by the mobile device to the serving base station regarding the strength or quality of signals from neighbouring cells. The serving base station uses this information to decide whether a handover to a different cell is necessary for maintaining the quality of service. The A4 report helps the serving base station make informed decisions about handovers while considering the mobile device's ongoing activities. An A5 report is used in GSM networks for handover decisions based on the mobile device's measurements of neighbouring cells. It contains information about the signal strength or quality of neighbouring cells and assists the serving base station in determining the appropriate handover actions. The UE 102 when transmits these measurement reports to the source BS 104 indicates about the cell of the target BS for which the HO is requested.

Now, in one non-limiting embodiment, if the UE 102 requests the source BS 104 for a HO for a cell of the neighbouring BS1 106 in its measurement reports. Then, the source BS 104 transmits the request for HO 112 to the neighbouring BS1 106. In this scenario, the neighbouring BS1 106 hosts that cell as SDL cell and it therefore start preparing for HO failure and subsequently denies the HO request 114 and the initiated HO fails thus not only degrading the HO KPIs (key performance indicators) of the neighbouring BS1 106 but also deteriorating the overall network efficiency.

In another scenario, if the UE 102 has requested from the source BS 104 for HO to a cell of the neighbouring BS2 108 in its transmitted 110 measurement reports then the source BS 104 transmits a HO request 116 to the neighbouring BS2 108 and since it does not host the SDL cell so it may receive the HO request and transmit the acknowledgement 118 to the source BS 104 as well. In this scenario, the HO KPIs may not degrade since the requested HO has been duly executed thus significantly reducing the possibility of overall network efficiency deterioration.

As emphasized earlier, the existing scenario illustrated in FIG. 1a may act as a blockade if the HO request from the source BS is transmitted for an SDL cell hosted by the target BS without knowledge about the same. To overcome this problem, the present disclosure proposes a method and system that may prevent outgoing HO requests for the SDL cell hosted by the neighbouring BSs which has been explained in detail in upcoming paragraphs.

To overcome or avoid the problem of degrading the HO KPIs, present disclosure makes the source base station aware about the SDL cell information so that no Handover request is triggered at first place for the SDL cell hosted by the target base station and as a result degradation of HO KPIs may be avoided. Same is explained in FIG. 1b of the present disclosure.

FIG. 1b illustrates an exemplary environment 100b where a UE (user equipment) 102 is being served by a source BS 104 at any instant of time. As mentioned earlier, in the present disclosure the source base station is made aware about the SDL cell information and same is maintained by the source base station at its end. Thus, when the UE may periodically send its measurement reports to the serving or source base station where, the UE 102 may request the source BS 104 for HO (Handover) to any other neighbouring BS (BS1, BS2, BS3) which may be defined in the measurement reports generated by it. In one non-limiting embodiment of the present disclosure, the UE 102 generates A3/A4/A5 measurement reports which contain the HO request for a specified neighbouring BS. Then, Source Base station 104 evaluate the measurement reports shared by UE 102. Based on the measurement report, now the source base station may check the neighbour cell table maintained at its end (with updated SDL cell information) and evaluate whether the request is for an SDL cell hosted by the target base station or not. Unlike earlier scenario, now Source is already maintaining the SDL cell information at its end, it may ignore the measurement report shared by UE for the SDL cell in the HO request. However, if the evaluation result turns out to be good for handover i.e., no request for SDL cell is present in the measurement report. Then, the Source Base station 104 may prepare for sending HO request to one of the target base station and UE 102 performs the cell change process. If cell change process is completed properly, UE 102 send cell change completion' message to the network via the target cell.

As depicted in the exemplary scenario, the neighbour cell table is maintained by each of the base station as each one of the base station may act as source base station or serving base station for the User Equipment(s) served by it. Considering an exemplary scenario, the source base station SB, 104 is serving the user equipment, UE 102. Generally, the source base station 104 sends a measurement control request message to the UE 102 to set the parameters to measure and set thresholds for those parameters. Its purpose is to instruct the UE 102 to send a measurement report to the source base station 104 as soon as it detects the thresholds. In such scenario, UE performs the measurement and report the “measurement result” to the source base station 104 via the current cell. It must be appreciated that the measurement report may contain various parameters other than the serving cell signal strength, neighbouring cell details, neighbouring cell signal strength information, cell to which handover is requested etc. however, the present disclosure aims for prevention of handover request for SDL cells thus, the content of measurement reports required for handover is only considered throughout the specification for ease of understanding.

Now a situation arises that requires handover to happen based on the measurement report data shared by the UE. Also, in the measurement report shared by UE 102, the UE 102 provides information about the cell of the target base station for handover. For example, the UE 102 shares the cell1 of BS1 in measurement report for handover. Once the measurement report is received by the source base station 104, it evaluates the same based on the neighbour cell table 114 maintained at its end and identifies that the cell1 of BS1 is an SDL cell thus, cannot be used for completion of HO request. In such scenario, the source base station 104 ignores the measurement reports shared by UE for the cell1 of BS1 and Handover preparation phase KPIs degradation may be avoided.

In another exemplary scenario, the UE 102 shares the cell1 of BS2 in measurement report for handover. Once the measurement report is received by the source base station 104, it evaluates the same through the neighbour cell table 114 maintained at its end (explained in upcoming paragraphs) and identifies that the cell1 of BS2 is not an SDL cell thus, can be used for completion of HO request. In such scenario, the source base station 104 may send a request message for handover to the target base station Bs2. The message contains the target Cell ID and the UE Context information. Upon receiving the Handover Request, the target bases station BS2 allocates required resources to provide the same quality of service to the UE 102 as provided by the source base station 104. The required resources may include resources for RRC to communicate with the UE 102 etc. Target base station BS2 then informs the source base station 104 about the prepared resources by sending Handover Request Acknowledge. In this way, the handover process gets initiated. Further detail regarding the handover process is not provided in the disclosure to avoid the diversion of attention of the reader from the intended scope of the disclosure. From the above, it may be understood that if the source base station 104 receives the measurement report for handover related to SDL cell of the target base station, then the source base station 104 ignores the measurement reports shared by UE 102 and in this way, Handover preparation phase KPIs degradation may be avoided.

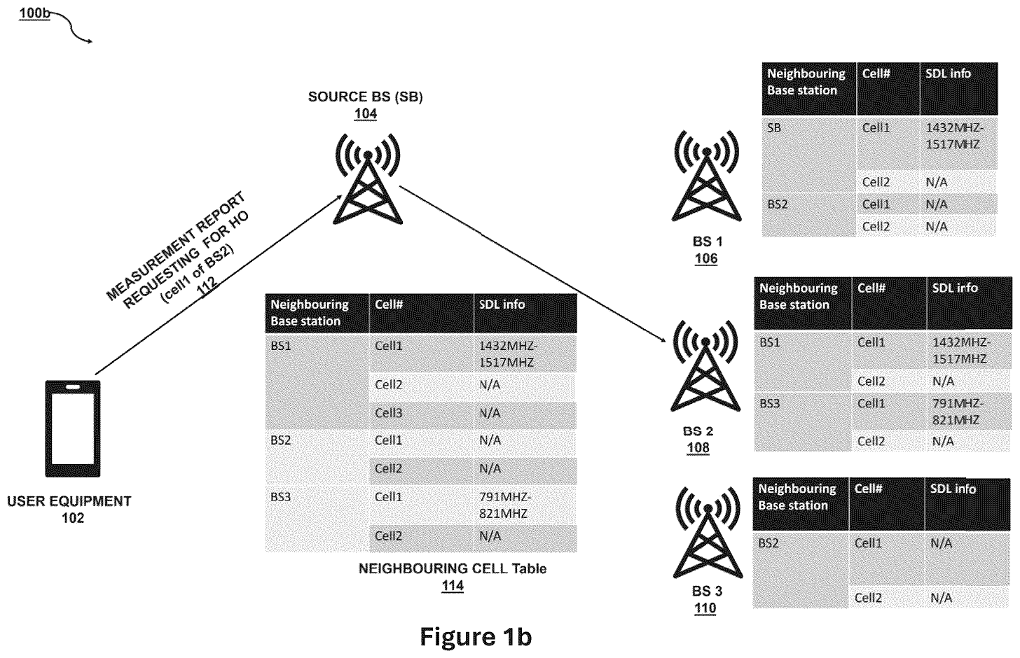

FIG. 2 depicts a block diagram 200 illustrating a source BS 204 to optimize the outgoing HO requests by taking into consideration whether the target BS hosts any SDL cell or not. In this, the source BS 204 comprises a processing unit 206 and a memory unit 208 such that the memory unit 208 in conjunction with the processing unit 206 is configured to receive the information about the surrounding neighbouring BSs and information about their related SDL cell configurations i.e., whether they host any SDL cell or not. After receiving this information, the memory unit 208 maintains this information in a neighbour cell table 210 at the source BS 204. The neighbour cell table 210 thus in turn stores all the information about the SDL cell corresponding to each of the neighbouring BSs which it may contact for the handover. In one non-limiting embodiment, the neighbour cell table 210 may be updated each and every time any neighbouring BS is added or removed from the source BS's 204 neighbourhood. When the UE 202, being served by the source BS 204, moves, or faces any kind of interference, it generates corresponding measurement reports for the consideration of the source BS 204 requesting HO. The memory unit 208 consequently stores these measurement reports 212 generated from the UE 202. These stored measurement reports 212 are then considered by the source BS 204 to analyse for which cell in the neighbouring BS a HO request has been generated by the UE 202. After analysing the neighbouring BS for which HO request has been generated, the source BS 204 looks up in the neighbour cell table 210 to determine whether the neighbouring BS hosts any SDL cell or not and whether the requested cell of the neighbouring base station is the SDL cell or not. For this, the processing unit 206 in conjunction with the memory unit 208 determines the condition for HO and if the requested cell is marked as SDL cell in the neighbour cell table for the target BS (one among the neighbouring BSs being requested for HO by the UE) then the HO request is not triggered by the source BS 204 for that SDL cell. In another scenario, if the target base station does not host any SDL cell, then the HO request is transmitted form the source BS 204 to the requested neighbouring BS i.e., target Base station. It must be appreciated that each of the source base station may be serving multiple UEs and any UE may send measurement report to the Source base station (serving the UE) for handover. The one base station which receives the measurement report is considered as the source base station throughout the disclosure and the one base station for which the handover is requested by the UE is considered as target base station throughout the description.

Now for the source BS 204 to receive the SDL cell information in context of the neighbouring BSs, the present disclosure provides different embodiments in which this information may be effectively retrieved by the source BS 204 beforehand so that it may prevent triggering of the outgoing HO request for any neighbouring BS which hosts the SDL cell. The different embodiments may be described in the upcoming paragraphs.

In one non-limiting embodiment, the network operator may pre-configure a particular frequency or a band of frequencies as SDL. In an exemplary embodiment, the SDL may be a single frequency which may be used as secondary cell for improving the utilization of spectrum resources e.g., 1.4 GHZ. In another exemplary embodiment, the SDL may be a band of frequencies or frequency band which is configured as SDL cell e.g., 1427MHZ-1432MHZ. In this embodiment, based on the preconfigured SDL cell information, network operator may update all the neighbouring BSs. The neighbour cell table 210 as illustrated in FIG. 2 may be used by the network operator to configure the SDL information in each and every BS within a cellular network. This approach would require the network operator to add or remove the information related to SDL cells of the neighbouring base stations whenever new BSs are added or removed from the given cellular network or there is change in the frequency of the SDL cell. As the information about the SDL cell is updated in the neighbour cell table 210 of the source BS 204, thus, it may not consider handover measurement reports received from the UE 202 for that particular cell i.e., SDL cell of the target BS. Hence, no HO request for that SDL cell (with designated frequency or frequency band) may be initiated by the source base station. In this way, degradation of HO KPIs may be avoided.

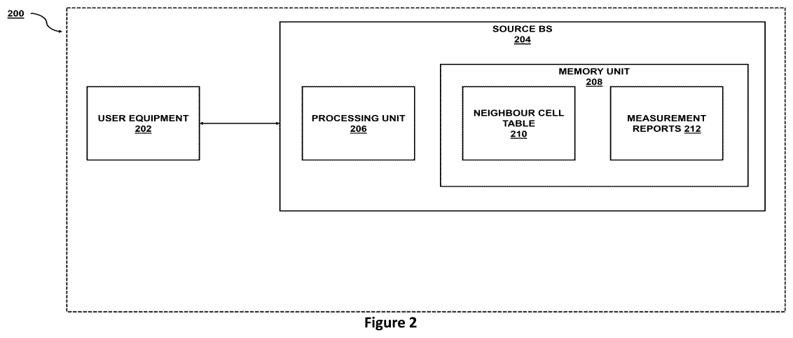

FIG. 3 depicts another exemplary environment 300 where the source base station 302 and the target base station 304 have been configured to communicate and exchange parameters between them while maintaining the overall network efficiency. To achieve this, the base stations are configured via X2 setup. The X2 interface plays a crucial role in facilitating communication and coordination between neighbouring base stations, referred to as eNB. Its primary functions encompass seamless handovers for mobile devices transitioning between adjacent cells, inter-cell coordination for efficient radio resource allocation and interference management, and direct data forwarding. The setup of the X2 interface involves a multi-step process, starting with neighbour discovery and configuration, where base stations exchange essential information. Once a neighbour relationship is established, the interface is configured with specific parameters and protocols. This setup is crucial for smooth handovers and optimizing network performance, especially as devices move across cell boundaries. Security measures like authentication and encryption are implemented to protect communication over the X2 interface from unauthorized access. Continuous communication and updates via the X2 interface enable neighbouring base stations to coordinate and manage resources effectively, ensuring an efficient and reliable network operation. So, to establish this connection, the source eNB 302 sends a X2 setup request 306 to the target eNB 308 which in turn sends a X2 setup response 308 thus establishing the X2 interface between the two neighbouring BSs. As mentioned earlier, the source eNB is the one which is currently serving the UE (for which handover request has been generated) and the target eNB is the one to which the source base station is approaching for handover.

Via this X2 interface, various Information Elements (IEs) are exchanged between the communicating BSs i.e., source base station and target base station. These IEs are fundamental units of data in telecommunication protocols and networking. They may act as carriers of specific pieces of information essential for effective communication between network entities and devices. These elements help in defining the content, parameters, and attributes of the information being exchanged within a network. They are designed to ensure standardized and consistent interpretation of data across different network components, enabling interoperability and seamless communication within complex network architectures. They may be configured to communicate radio resource management parameters, quality of service parameters, security parameters, network configuration and associated interference among many other parameters. However, in the conventional scenario, the IEs have not been yet configured to communicate any information related to SDL cell hosted by any base station during communication between BSs.

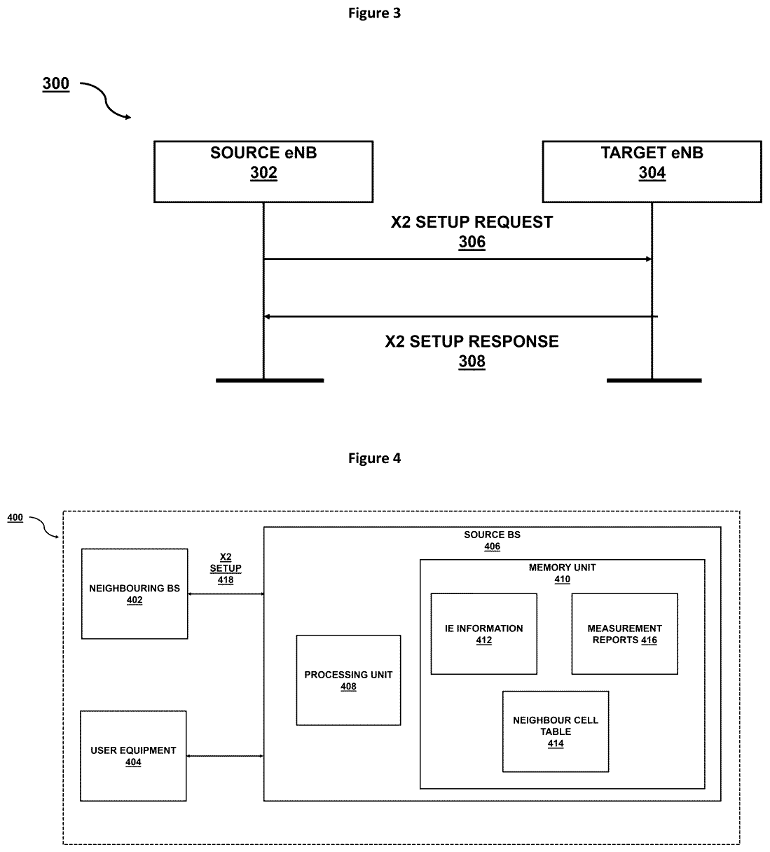

Present disclosure discloses configuring of the IE message(s) for containing SDL cell information. The IE(s) message from at least one base station of the one or more base stations neighbouring the source base station is exchanged with the source base station. The at least one base station is the target base station with which the source base station is establishing a link for handover. The IE message may comprise SDL cell information corresponding to the at least one base station i.e., target base station. It may be appreciated that for the base station 302, the base station 304 is acting as the target base station whereas for the base station 304, the base station 302 may act as the target base station. In an exemplary embodiment, the IE message may be a single message that contains the SDL cell information. In another exemplary embodiment, there are more than one IE messages that carries the SDL cell information. At one instance, the node 302 (source base station) may request SDL cell information of the node 304 (target base station) and the node 304 may share its SDL cell information via the IE(s) to the node 302 in response to the request. At another instance, the node 304 (now acting as source base station) may request SDL cell information of the node 302 (now acting as target base station) and the node 302 may share its SDL cell information via the IE(s) to the node 304 in response to the request. In this way, the SDL cell information via IE(s) may be exchanged between two base stations and accordingly, each of the base station may update the neighbour cell table maintained at their end. Once, the neighbour cell table is updated for the SDL cell information and the corresponding neighbouring base station that is hosting the SDL cell. Thereafter, when a measurement report is shared by the UE for handover and if that contains request for the SDL Cell hosted by the target base station. Then, based on the updated neighbour cell table, the Source base station may avoid the triggering of handover request for the SDL cell hosted by the target base station. In this way, by receiving the SDL cell information through the Information element(s) and updating the same in the neighbour cell table of source base station may help in avoiding the degradation of handover KPIs. Same is explained in more detail in FIG. 4.

FIG. 4 depicts an exemplary block diagram 400 illustrating a system to exchange SDL cell information via IEs in a X2 setup interface between two base stations i.e., neighbouring base station 402 and the source BS 406. The source BS 406 and its neighbouring BS 402 have been configured to communicate with each other via X2 setup 418. In one of the non-limiting embodiments, apart from regular IEs, at least one or more IEs may be exchanged between the two communicating eNB which may include SDL cell information, in accordance with the disclosure of the present application, i.e., whether the neighbouring BS 402 host any SDL cell or not and which frequency or frequency band is maintained as SDL cell by the neighbouring BS. This IE message information 412 related to the SDL cell information may be received by the memory unit 410 of the source eNB 406 and may be stored in the neighbour cell table 414. When the UE 404 generates measurement reports and transmits it to the source BS 406 then these measurement reports 416 are stored in the memory unit 410. Consequently, the processing unit 408 in conjunction with the memory unit 410 analyses the measurement reports 416 and based on the determination whether the requested cell hosted by the target BS is an SDL cell or not, the source BS may determine the condition for HO. In particular, after checking from the neighbour cell table 412, if the cell of the target BS requested in the measurement reports 416 from the UE 404 is determined to be SDL cell, then HO request may not be generated, however, if the cell requested in the measurement report is not SDL cell, then the source BS 406 initiates outgoing HO request for the neighbouring BS 402 i.e. target base station.

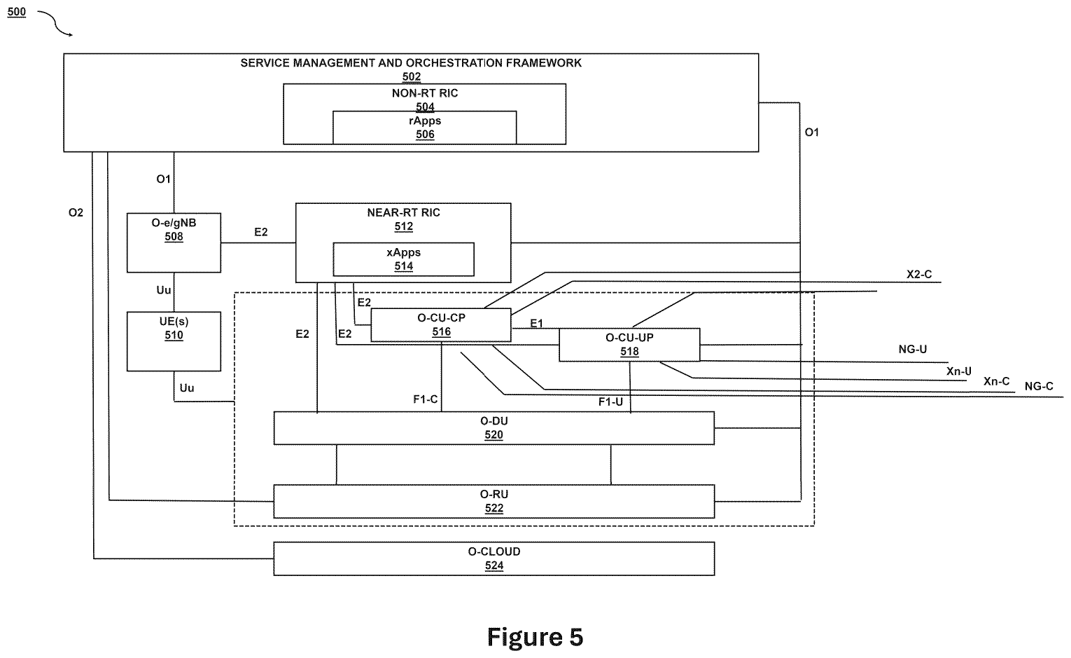

In yet another embodiment, the present disclosure aims to provide SDL cell information to the source BSs by deploying a service management and orchestration framework in O-RAN. To elaborate, Service Management and Orchestration (SMO) framework refers to the comprehensive management and orchestration of network services in modern telecommunications. It involves the automation and coordination of network functions and resources throughout the service lifecycle, encompassing creation, activation, monitoring, scaling, and termination of services. Orchestrating different network functions is a key aspect of ensuring harmonious operation between different entities to meet service requirements. On the other hand, Open Radio Access Network (O-RAN) is an industry initiative aiming for a more open, interoperable, and flexible radio access network. It promotes the use of open standards and interfaces, virtualization of network functions, and decomposition of hardware and software components. O-RAN integrates intelligence, artificial intelligence (AI), and automation, enhancing network performance, resource allocation, and operational efficiency. The relationship between SMO framework and O-RAN lies in SMO's potential to leverage O-RAN principles for efficient service orchestration, dynamic resource allocation, and end-to-end service management within the radio access network. By utilizing O-RAN's open and interoperable architecture, SMO framework can optimize the management of radio access network services, ultimately advancing the telecommunications landscape. The architecture and operating process of SMO framework in context of O-RAN has been explained in the upcoming paragraphs in reference to FIG. 5.

FIG. 5 of the present disclosure depicts a block diagram 500 illustrating the O-RAN system architecture in detail. The architecture may be divided into two primary components: the management side and the radio side. On the management side, Service Management and Orchestration (SMO) framework 502 serves as a centralized entity responsible for managing and orchestrating various aspects of the network. At its core, there is a non-real time RAN Intelligent Controller (non-RT RIC) 504, a crucial element for intelligent decision-making and control. This component employs artificial intelligence and machine learning workflows to optimize network performance and resource allocation, enhancing efficiency. The management side may also include the O-Cloud 524, a cloud computing platform with physical infrastructure nodes hosting essential O-RAN functions. The O-Cloud 524 is also equipped with appropriate management and orchestration functions, making it a dynamic and responsive part of the architecture.

On the radio side, the focus is on the physical elements that make up the radio access network. This includes near-RT RIC 512, O-DU 520, O-RU 522, O-CU-CP 516, and O-CU-UP 518. These components collectively enable radio communication, encompassing control plane functions for signalling and user plane functions for actual data transmission. Additionally, the architecture considers the possibility of integrating O-eNB/gNB, an essential part of 5G and beyond.

In 3GPP 5G RAN, the base station (gNB) is split into two logical functions: the centralized unit (CU) and the distributed unit (DU). Both may be virtualized (vDU, vCU) and these two entities are connected by F1-C and F1-U interfaces. The O-RAN Alliance specifications further disaggregate the CU and DU network functions and introduce other network functions, such as near-real-time radio intelligent controllers (RIC) and non-real-time RIC, and service management and orchestration (SMO) framework, which are interconnected over additional open interfaces (E1, E2, O1, O2, A1), and utilize 3rd party applications (3rd party rApps/xApps). RAN intelligent controllers (RIC) play an important role in the optimized performance and responsiveness of radio access networks. The control loops in RIC network functions operate under strict latency requirements and provide interfaces to rApps/xApps for getting RAN metrics and enrichment information. The RICs implement AI/ML workflow of model learning and inference for optimization of RAN resources. The RIC framework enables third-party rApps/xApps, and these third-party rApps/xApps are authenticated and only authorized access is provided to RIC interfaces. In reference to this, the upcoming paragraphs of the present disclosure have been explained in conjunction with this architecture illustrated in FIG. 5.

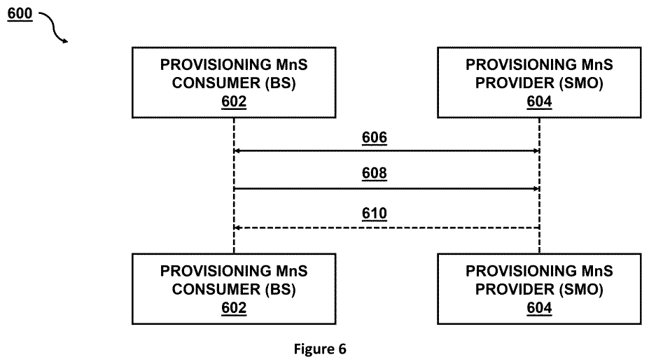

FIG. 6 in turn depicts a block diagram 600 illustrating the process of establishing session between SMO framework 502 and the source base station (0-e/gNB) 508 of FIG. 5. Skilled people may appreciate that there may be multiple O-eNB or O-gNB available in network which are in communication with the SMO framework 502. However, to make the concept easy to understand only one BS 602 is considered in the FIG. 6. In an exemplary embodiment, the BS 602 may be a source BS. According to FIG. 6, Provisioning MnS consumer (i.e., BS) 602 sends a request for establishing session 606 to Provisioning MnS Provider (i.e.,SMO framework) 604. The SMO framework may provide notification to the BS about the SDL cell information in this approach. However, to receive the SDL cell information, a session is established between the SMO framework 604 and the base station 602. There are various configurations and set of protocols available through which SMO framework 604 may establish session/connection with the base stations and in turn interact with base stations. In one approach, NETCONF is used to provide a standardized and efficient way to configure, manage, and monitor network devices and services. By deploying this NETCONF/YANG based models, base station (e.g., Source BS) and SMO framework may establish NETCONF session for sharing information and policies. In another embodiment, REST/HTTPs based configuration may be used for the defined purpose. In yet another embodiment, ONAP/VES based configuration may be used for the intended purpose. A person skilled in the appreciate that these protocols and models may be used for the same purpose. However, for the ease of understanding, the explanation in the upcoming paragraphs is provided with respect to NETCONF configuration only, thus same should not be construed as a limitation.

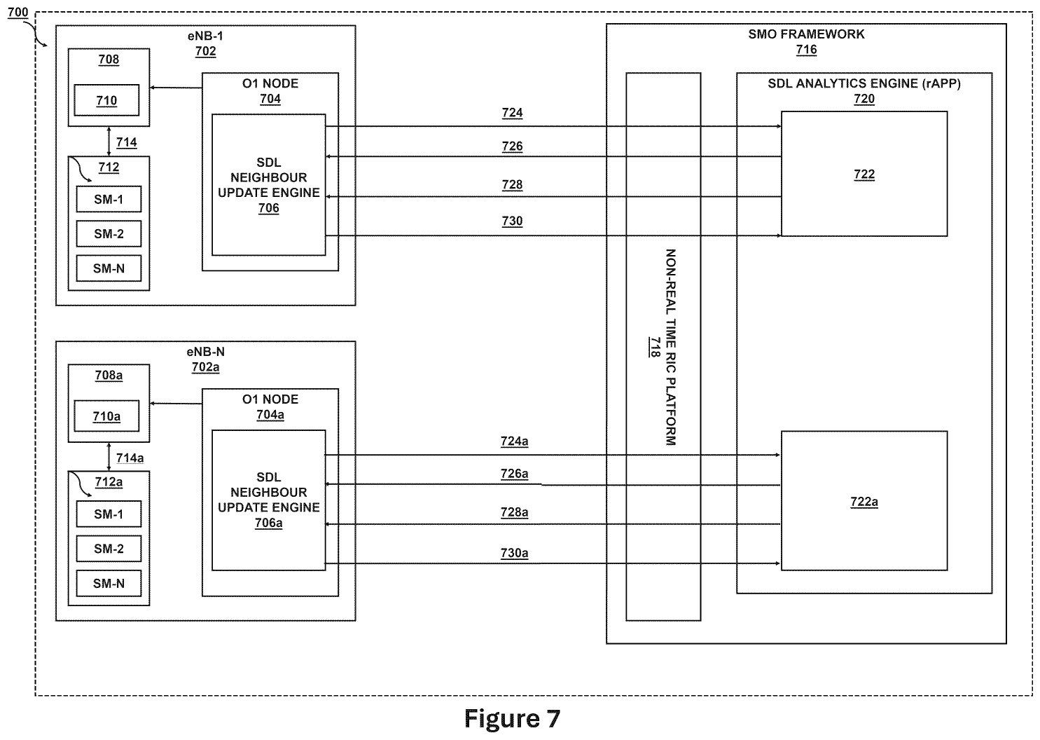

For session establishment 606, SSH (Secure Shell) or TLS (Transport Layer Security) handshakes are initiated which are crucial for establishing a secure and authenticated communication channel between the SMO framework and the base station. It ensures that both parties (eNB and SMO framework) agree on encryption methods, exchange cryptographic keys, and validate each other's identities before proceeding further with secure data exchange. Once the session is established, the base station 602 sends a message in step 608 to the SMO framework 604. In response to the message shared by the base station, SMO framework 604 exchanges the session ID and capabilities information in step 610 with the neighbouring base station 602 using NETCONF protocol. The capability information indicates one or more operations supported by the SMO framework 604. These one or more operations may be getting configuration of the NETCONF protocol session, updating configuration of the NETCONF protocol session, locking, or unlocking configuration of the NETCONF protocol session, closing the NETCONF protocol session, and terminating the NETCONF protocol session. The exchange of information post the session establishment is explained in upcoming paragraphs with reference to FIG. 7.

FIG. 7 describes that each of the base stations establish NETCONF session via O1 interface with the SMO framework in accordance with an embodiment of the present disclosure. However, for ease of the understanding, only two base stations are presented in the FIG. 7. A skilled person may appreciate that there are multiple base stations that interact with the SMO for sharing the information. First, the interface link between the O1 node 704 and the non-RT RIC 718 is set up based on NETCONF session. In the O-RAN architecture, each of the disaggregated network function O-CU-CP, O-CU-UP and O-DU of a gNB (e.g., base station) or a combined O-eNB (base station) are called the O1 nodes. O1 nodes support O1 interface towards non-RT RIC. Further, in an exemplary embodiment, O1 node 704 subscribes to the rApps running in the non-RT RIC 718 based on RIC subscription procedure. For example, the O1 node 704 may send a request to the SMO framework 716 for creating a subscription to receive event notifications upon occurrence of at least one event. Similarly, in another exemplary embodiment, the rApps running in the non-RT RIC 718 subscribe to the O1 node 704 for certain events. For example, the rApps may subscribe for events such as changes in the SDL cell configuration or modification of SDL cell status (SDL to Non-SDL or Non-SDL to SDL). Similarly, the O1 node 704 may subscribe for events such as update in neighbouring base stations and their SDL cell information. Further, the SMO framework 716 may provide a response that the subscription is created successfully. Based on the subscription, whenever there is an update/change available in SDL cell related information of the O1 node 704, an event gets triggered and SMO framework 716 receives the notification about this event. As per other subscription, once the updated SDL cell information is available with the SMO framework 716, the SMO framework 716 may send notification about the corresponding event i.e., updated SDL cell information to each of the base stations neighbouring the SDL cell. In this way, subscription procedure may be performed.

Once the subscription procedure is carried out successfully, each of the O1 node 704 may share the list of its SDL cell and its neighbour details with the rApp running in the non-RT RIC 718. For example, based on NETCONF protocol, the O1node may share the information about the SDL cell and its neighbour base stations in edit-config RPC message 724. In response, the SDL analytics Engine rApp 720 may share a response/acknowledge message in edit-config RPC message 726. The non-RT RIC may maintain records for the shared information by each of the O1 node. As the subscription is set for the SDL cell information, thus if the shared information from the O1 node 704 contains SDL cell then rApp 720 may notify the SDL cell information to each of the neighbour of the SDL cell in edit-config RPC message 728 or a notification is shared from the SMO framework 716 to each of the neighbours of the SDL cell. For example, eNB-1 i.e., node 702 is having a SDL cell thus, whenever the information is shared by the O1node 704 of the eNB-1 to the SMO framework 716 then, SMO analytics engine rApp 720 may analyze the SDL cell information and identify all the neighbouring base stations of the eNB-1 702. Further, SMO analytics engine rApp 720 maintains list of neighbours of base stations and list of SDL carriers of the neighbours for each base station. For example, list of x2App neighbours and list of SDL carriers of the neighbours for eNB1 is maintained in 722. Based on the analysed information, SMO analytics engine rAPP 720 may notify all the neighbours of the node 702 about the SDL cell information in the edit-config RPC message 728. Further, the O1 node may analyze the information provided in the edit-config RPC message 728 and send a response/acknowledgement message in edit-config RPC message 730 to the rApp. Additionally, each O1node may act as a O1Manager (O1MGR) to update their neighbour cell table for the SDL cell information. In Particular, the SDL neighbour update engine 706 of the O1 node 704 may perform this updation at O1 node 704.

In the same way, at O1 node, if there is any change occurs i.e., change in SDL configuration or status of any of the served SDL cell then the O1 node may pass the SDL cell information to each of the other subscriber managers SM1, SM2 . . . . SMN present at the base station. The subscriber manager (SM1, SM2 . . . , SMN) may also send Neighbour Modify Information to Self-optimizing Network (SON) to update the Neighbour as SDL cell and meanwhile update its Neighbour cell table as well. The SON updates the SDL configuration 714 via Management Agent API (maapi) and provide these changes to Element Management System (EMS).

Thus, whenever, a measurement report is received by one of the subscriber managers from UE for handover then, the particular subscriber manager (SM) may check the neighbour cell table maintained by the O1node and accordingly based on the information available in the neighbour cell table, it may determine whether the requested cell is marked as SDL or not. In case, the requested cell in the measurement report is the SDL cell then the base station may avoid the triggering of the handover for the requested SDL cell and ignores the measurement report otherwise if the requested cell is not a SDL cell, according to the neighbour cell table, then the base station may take action to serve the request and initiate the Handover process. In this way, by using the SMO as well, the degradation of handover KPIs may be avoided.

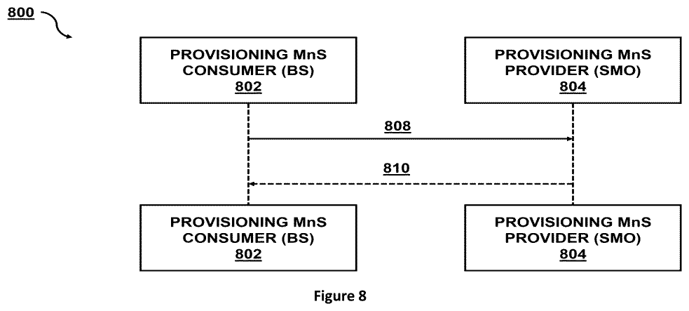

FIG. 8 in turn depicts a block diagram 800 illustrating the process of terminating the established session between SMO 502 and the base station (O-e/gNB) 508 of FIG. 5. In this, Provisioning MnS consumer (BS) 802 sends a request 808 for terminating the NETCONF session 806 to Provisioning MnS Provider (SMO framework) 804. The SMO framework 804 reciprocates via message 810 and NETCONF (Network Configuration) session is terminated between the two entities. In an exemplary embodiment, the Provisioning MnS consumer 802 may be a source base station.

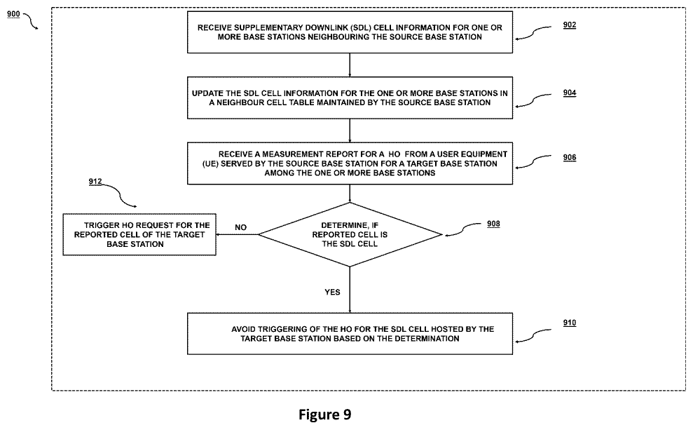

FIG. 9 illustrates a flowchart 900 of an exemplary method for optimizing HO request by the source BS, in accordance with an embodiment of the present disclosure. The method 900 may also be described in the general context of computer executable instructions. Generally, computer executable instructions may include routines, programs, objects, components, data structures, procedures, modules, and functions, which perform specific functions or implement specific abstract data types.

The order in which the method 900 is described is not intended to be construed as a limitation, and any number of the described method blocks may be combined in any order to implement the method. Additionally, individual blocks may be deleted from the methods without departing from the spirit and scope of the subject matter described.

At step 902, the method 900 may include receiving Supplementary Downlink (SDL) cell information for one or more base stations neighbouring the source base station, wherein the one or more base stations neighbouring the source base station host an SDL cell. In one non-limiting embodiment, to receive the SDL cell information, the source BS may host at least one processor which may be configured in conjunction with the memory to implement the method step 902. Further, in one non-limiting embodiment of the present disclosure, the source base station may receive at least one Information Element (IE) message from at least one base station of the one or more base stations neighboring the source base station, wherein the at least one IE message comprises SDL cell information corresponding to the at least one base station neighbouring the source base station. In another non-limiting embodiment, the source base station may receive a preconfigured SDL-frequency corresponding to the one or more base stations neighboring the source base station from a network operator. In yet another non-limiting embodiment, the source base station may receive the SDL cell information from a Service management and orchestration (SMO) framework. For achieving this, a NETCONF protocol session is established between the SMO framework and the source base station and consequently SDL cell information of the one or more base stations neighboring the source base station is received from the SMO framework.

At step 904, the method 900 may include updating the SDL cell information for the one or more base stations in a neighbour cell table maintained by the source base station. In one non-limiting embodiment, at least one processor in conjunction with the memory may be configured to update the SDL cell information in the neighbour cell table being maintained by the source BS.

At step 906, the method 900 may include receiving a measurement report for a HO from a user equipment (UE) served by the source base station for a target base station. The target base station is among the one or more base stations neighbouring the source base station. In one non-limiting embodiment, at least one processor in conjunction with the memory may be configured to receive the measurement reports. In another non-limiting embodiment, at least one processor in conjunction with the memory may be configured to analyse in reference to the neighbouring cell table, information about the SDL cell information of the target BS requested by the UE in the received measurement reports.

At step 908, the method 900 may include determining from the neighbour cell table, whether a cell reported for the HO in the measurement report is the SDL cell hosted by the target base station, in response to the analysed measurement reports. In one non-limiting embodiment, at least one processor in conjunction with the memory may be configured to determine whether a cell reported for HO in the measurement report is an SDL cell.

At step 910, the method 900 may include avoiding triggering of the HO for the SDL cell hosted by the target base station based on the determination. In one non-limiting embodiment, at least one processor in conjunction with the memory may be configured to avoid triggering of the HO request in case the requested cell by the UE is an SDL cell.

At step 912, the method 900 may include initiate triggering of the HO for the reported cell of the target base station if the reported cell is determined to as non-SDL cell. In one non-limiting embodiment, at least one processor in conjunction with the memory may be configured to initiate triggering of the HO for the cell reported in the measurement report if the cell is determined as non-SDL cell.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory 208 on which information or data readable by a processor 206 may be stored. Thus, a computer-readable storage medium may store instructions for execution by one or more processors, including instructions for causing the processor(s) to perform steps or stages consistent with the embodiments described herein. The term “computer- readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

Suitable processors include, by way of example, a general-purpose processor, a special purpose processor, a conventional processor, a digital signal processor (DSP), a graphic processing unit (GPU), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

### ADVANTAGES OF THE EMBODIMENT OF THE PRESENT DISCLOSURE ARE ILLUSTRATED HEREIN—

In an embodiment, the present disclosure provides techniques for providing prior information to a source BS about the SDL cell of its one or more neighbouring BSs, thereby enabling the source BS to not initiate triggering of HO request for that particular cell at the first place thus avoiding HO failure which may lead to degradation of HO KPIs and deterioration of overall network efficiency.

In an embodiment, the present disclosure provides techniques for enhancing the user experience by not initiating any HO which may not be effectively accomplished thus enabling the user a seamless access to existing/serving BS's services, avoiding call drops or any other interference generated due to failed HO process.

Top of Form

I/We claim:

1. A method performed by a source base station for optimizing Handover (HO) requests, the method comprising:
receiving Supplementary Downlink (SDL) cell information for one or more base stations neighbouring the source base station, wherein the one or more base stations neighbouring the source base station host an SDL cell;
updating the SDL cell information for the one or more base stations in a neighbour cell table maintained by the source base station;
receiving a measurement report for a HO from a user equipment (UE) served by the source base station for a target base station among the one or more base stations; and
in response to receiving the measurement report:
determining from the neighbour cell table, whether a cell reported for the HO in the measurement report is the SDL cell hosted by the target base station; and
avoiding triggering of the HO for the SDL cell hosted by the target base station based on the determination.

2. The method as claimed in claim 1, wherein receiving the SDL cell information for the one or more base stations neighbouring the source base station comprises:
receiving at least one Information Element (IE) message from at least one base station of the one or more base stations neighbouring the source base station, wherein the at least one IE message comprises SDL cell information corresponding to the at least one base station.

3. The method as claimed in claim 1, wherein receiving the SDL cell information for the one or more base stations neighbouring the source base station comprises:
receiving a preconfigured SDL-frequency corresponding to the one or more base stations neighbouring the source base station from a network operator.

4. The method as claimed in claim 1, wherein receiving the SDL cell information for the one or more base stations neighbouring the source base station comprises:
establishing a NETCONF protocol session between a Service management and orchestration (SMO) framework and the source base station; and
receiving SDL cell information of the one or more base stations neighbouring the source base station from the SMO framework, wherein the SDL cell information of the SDL cell hosted by the one or more base stations is provided to the SMO framework by the one or more base stations.

5. The method as claimed in claim 4, further comprising:
sending a request to the SMO framework for creating a subscription to receive event notifications upon occurrence of at least one event, wherein the at least one event comprises a change in SDL cell information;
receiving a response from the SMO framework that the subscription is created successfully; and
receiving the event notifications upon occurrence of the at least one event.

6. The method as claimed in claim 4, wherein establishing the NETCONF Protocol session between a Service management and orchestration (SMO) framework and the source base station comprises:
exchanging session ID and capability information between the source base station and the SMO framework, wherein the capability information indicates one or more operations supported by the SMO framework, and wherein the one or more operations are selected from a group comprising:
getting configuration of the NETCONF protocol session, updating configuration of the NETCONF protocol session, locking/unlocking configuration of the NETCONF protocol session, closing the NETCONF protocol session, and terminating the NETCONF protocol session.

7. The method as claimed in claim 1, wherein the SDL cell information comprises:
a single frequency; or
a range of frequencies.

8. A source base station for optimizing Handover (HO) requests comprising:
a memory; and
at least one processor coupled to the memory and configured to:
receive Supplementary Downlink (SDL) cell information for one or more base stations neighbouring the source base station, wherein the one or more base stations neighbouring the source base station host an SDL cell;
update the SDL cell information for the one or more base stations in a neighbour cell table maintained by the source base station;
receive a measurement report for a HO from a user equipment (UE) served by the source base station for a target base station among the one or more base stations;
determine from the neighbour cell table, whether a cell reported for the HO in the measurement report is the SDL cell hosted by the target base station in response to the received measurement report; and
avoid triggering of the HO for the SDL cell hosted by the target base station based on the determination.

9. The source base station as claimed in claim 8, wherein to receive the SDL cell information for one or more base stations neighbouring the source base station, the at least one processor is configured to:
receive at least one Information Element (IE) message from at least one base station of the one or more base stations neighbouring the source base station, wherein the at least one IE message comprises SDL cell information corresponding to the at least one base station.

10. The source base station as claimed in claim 8, wherein to receive the SDL cell information for one or more base stations neighbouring the source base station, the at least one processor is configured to:
receive a preconfigured SDL-frequency corresponding to the one or more base stations neighbouring the source base station from a network operator.

11. The source base station as claimed in claim 8, wherein to receive the SDL cell information for one or more base stations neighbouring the source base station, the at least one processor is configured to:
establish a NETCONF protocol session between a Service management and orchestration (SMO) framework and the source base station; and
receive SDL cell information of the one or more base stations neighbouring the source base station from the SMO framework, wherein the SDL cell information of the SDL cell hosted by the one or more base stations is provided to the SMO framework by the one or more base stations.

12. The source base station as claimed in claim 11, wherein the at least one processor is configured to:
send a request to the SMO framework for creating a subscription to receive event notifications upon occurrence of at least one event, wherein the at least one event comprises a change in SDL cell information;
receive a response from the SMO framework that the subscription is created successfully; and
receive the event notifications upon occurrence of the at least one event.

13. The source base station as claimed in claim 11, wherein to establish the NETCONF protocol session between a Service management and orchestration (SMO) framework and the source base station, the at least one processor is configured to:
exchange session ID and capability information between the source base station and the SMO framework, wherein the capability information indicates one or more operations supported by the SMO framework, and wherein the one or more operations are selected from a group comprising:
getting configuration of the NETCONF protocol session, updating configuration of the NETCONF protocol session, locking/unlocking configuration of the NETCONF protocol session, closing the NETCONF protocol session, and terminating the NETCONF protocol session.

14. The source base station as claimed in claim 8, wherein the SDL cell information comprises:
a single frequency; or
a range of frequencies.

15. A non-transitory computer readable media for optimizing Handover (HO) requests at a source base station, the non-transitory computer readable media comprising one or more instructions which, when executed by at least one processor cause the at least one processor to:
receive Supplementary Downlink (SDL) cell information for one or more base stations neighbouring the source base station, wherein the one or more base stations neighbouring the source base station host an SDL cell;
update the SDL cell information for the one or more base stations in a neighbour cell table maintained by the source base station;
receive a measurement report for a HO from a user equipment (UE) served by the source base station for a target base station among the one or more base stations;
determine from the neighbour cell table, whether a cell reported for the HO in the measurement report is the SDL cell hosted by the target base station in response to the received HO measurement report; and
avoid triggering of the HO for the SDL cell hosted by the target base station based on the determination.
